(19) United States
(12) Patent Application Publication
(10) Pub. No.: US 2019/0156378 A1
(43) Pub. Date: May 23, 2019

(54) SYSTEMS AND METHODS FOR OBTAINING AND UTILIZING ONLINE CUSTOMER SERVICE REVIEWS OF INDIVIDUAL EMPLOYEES

(71) Applicant: ReviewBuzz Inc., Vista, CA (US)

(72) Inventor: Michael MONTANO, Vista, CA (US)

(21) Appl. No.: 16/259,968

(22) Filed: Jan. 28, 2019

Related U.S. Application Data
(63) Continuation of application No. 14/061,745, filed on Oct. 23, 2013, now abandoned.
(60) Provisional application No. 61/717,548, filed on Oct. 23, 2012.
(60) Provisional application No. 61/717,549, filed on Oct. 23, 2012.
(60) Provisional application No. 61/717,550, filed on Oct. 23, 2012.
(60) Provisional application No. 61/717,551, filed on Oct. 23, 2012.

(51) Int. Cl. G06Q 30/02; G06Q 10/06; G06Q 30/00

(52) U.S. Cl. CPC G06Q 30/0282; G06Q 30/016; G06Q 10/06398

(57) ABSTRACT

Systems and methods are provided for obtaining and utilizing online customer service reviews for an individual employee of a service provider such as a business. When a customer receives service from a service provider or business with at least one employee that provided the service, the customer is asked to create an online review for the individual employee which provided the service as opposed to the company in general. The individual employee and service provider in the review are identified and matched with the correct service provider and employee, after which the review is transmitted to the service provider and employee. The reviews may be aggregated into individual profiles for each employee, which can be displayed on the business website or an employee profile website to advertise the employee's customer service. The employee profiles can also be used to award and incentivize each employee to provide better customer service.

### CROSS-REFERENCE TO RELATED APPLICATIONS

This application is a continuation of U.S. patent application Ser. No. 14/061,745, filed Oct. 23, 2013, entitled “SYSTEMS AND METHODS FOR OBTAINING AND UTILIZING ONLINE CUSTOMER SERVICE REVIEWS OF INDIVIDUAL EMPLOYEES,” which claims priority to U.S. Provisional Application Ser. No. 61/717,548, filed Oct. 23, 2012, entitled “SYSTEMS AND METHODS FOR OBTAINING AND BROADCASTING CUSTOMER SERVICE REVIEWS,” U.S. Provisional Application Ser. No. 61/717,551, filed Oct. 23, 2012, entitled, “MOBILE APPLICATION-BASED PLATFORMS FOR CUSTOMER SERVICE REVIEWS,” U.S. Provisional Application Ser. No. 61/717,550, filed Oct. 23, 2012, entitled, “SYSTEMS AND METHODS FOR ORGANIZING AND MARKETING CUSTOMER SERVICE REVIEWS,” and U.S. Provisional Application 61/717,549, filed Oct. 23, 2012, entitled, “SYSTEMS AND METHODS FOR OBTAINING AND UTILIZING CUSTOMER SERVICE REVIEWS OF INDIVIDUAL EMPLOYEES,” the contents of which are hereby incorporated by reference in their entirety.

### BACKGROUND

### 1. Technical Field

The embodiments described herein are related to obtaining and utilizing online customer service reviews, and more particularly to requesting and utilizing online customer service reviews for an individual employee of a service provider.

### 2. Related Art

Customer service reviews are an invaluable asset to any business which interacts with a customer. Whether the business is a direct service provider where customers are directly provided with a service by an employee (ex: plumber, phone company) or an indirect service provider where customers are provided with a product through the employee (ex: retail store or restaurant), the customer's experience with the employee often has a significant effect on the customer's desire to use that business in the future.

In order to ensure that employees are providing good customer service, businesses often request customer service reviews. Businesses may use the customer service reviews internally to evaluate their business practices, evaluate employees and generally improve the customer service experience. Some businesses will also publish the customer reviews for other customers to see as a marketing or advertising tool to demonstrate their ability to provide good customer service. More recently, online customer service reviews have become an industry unto themselves, with many third-party customer review companies being created where customers can post reviews of their customer service experiences. These companies will then post the customer reviews on a website so that potential customers can sort through reviews for multiple competing businesses and determine which company to do business with. Websites that provide business listings, such as search engines or shopping sites, will also integrate customer service reviews into their listings, so that customers searching for a local business can look for a nearby service or product while also reading the reviews of that business.

Despite the potential benefits, customer service reviews—especially online reviews—can be fraught with peril. The Internet is a haven of unfiltered content where people often make anonymous comments that they would never say in person, and where people make potentially libelous statements anonymously without regard to any potential consequences. For businesses which receive online customer service reviews, negative or false reviews can be devastating, as the reviews, even if untrue, are often prominently displayed and impossible to erase. More difficult is the fact that customers are much more likely to post negative reviews when they've had a bad experience than they are to post positive reviews when they've had a good experience.

### SUMMARY OF THE INVENTION

The embodiments described herein are directed to systems and methods for obtaining and utilizing online customer service reviews for an individual employee of a service provider such as a business. When a customer receives service from a service provider or business with at least one employee that provided the service, the customer is asked to create an online review for the individual employee which provided the service as opposed to the company in general. The individual employee and service provider in the review are identified and matched with the correct service provider and employee, after which the review is transmitted to the service provider and employee. The reviews may be aggregated into individual profiles for each employee, which can be displayed on the business website or an employee profile website to advertise the employee's customer service. The employee profiles can also be used to award and incentivize each employee to provide better customer service.

In one aspect of the invention, a method of obtaining online customer service reviews for an individual employee of a service provider comprises the steps of: receiving an online customer service review of the individual employee of the service provider based on customer service received from the individual employee; identifying the service provider and individual employee in the received online customer service review; matching, using a computer with a processor and a memory, the identified service provider and individual employee in the received online customer service review with a list of service providers and individual employees; and transmitting the online customer service review to the matched service provider.

In another aspect of the invention, a system of obtaining online customer service reviews for an individual employee of a service provider, comprises: a customer device configured to complete an online customer service review of the individual employee of the service provider based on customer service received from the individual employee and transmit the online customer service review; a review server configured to: receive the online customer service review of the individual employee; identify the service provider and individual employee in the received online customer service review; match the identified service provider and individual employee in the received online customer service review with a list of service providers and individual employees stored in an employee and service provider database; and transmit the online customer service review; and a service provider server of the matched service provider which receives the transmitted online customer service review.

In a further aspect of the invention, a method of obtaining online customer service reviews for an individual employee of a service provider, comprising the steps of: requesting that a customer of the service provider complete an online customer service review of the service provider; receiving the online customer service review; identifying content of the online customer service review related to the individual employee; and associating the identified content with an individual employee review profile.

Additional aspects related to these embodiments will be set forth in part in the description which follows, and in part will be apparent from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a system of obtaining and utilizing online customer service reviews, according to one embodiment of the invention;

FIG. 2 illustrates a method of obtaining and utilizing online customer service reviews, according to one embodiment of the invention;

FIG. 3 illustrates a system and method of requesting, receiving, organizing and broadcasting customer service reviews, according to one embodiment of the invention;

FIGS. 4A and 4B illustrate graphical user interfaces (GUIs) for managers and administrators to manage the reviews, according to one embodiment of the invention;

FIGS. 5A-5F illustrate GUIs of an employee review profile, according to one embodiment of the invention;

FIGS. 6A-6C illustrate GUIs of a business reviewing dashboard which displays summaries of review information, according to one embodiment of the invention; and

FIG. 7 illustrates a block diagram of an embodiment of a computer/server system upon which an embodiment of the inventive methodology may be implemented.

### DETAILED DESCRIPTION OF THE INVENTION

In the following detailed description, reference will be made to the accompanying drawings. The aforementioned accompanying drawings show by way of illustration and not by way of limitation, specific embodiments and implementations consistent with the principles of the present invention. These implementations are described in sufficient detail to enable those skilled in the art to practice the invention, and it is to be understood that other implementations may be utilized and that structural changes and/or substitutions of various elements may be made without departing from the scope and spirit of the invention. The following detailed description is, therefore, not to be construed in a limited sense. Additionally, the various embodiments of the invention as described may be implemented in the form of software running on a general purpose computer in the form of a specialized hardware, or combination of software and hardware.

The embodiments described herein provide for an Internet-based system for obtaining and utilizing online customer service reviews for an individual employee of a service provider. By requesting that customers complete online reviews of individual employees that provided a particular service, the customer is more likely to complete a review due to their direct interaction with the employee, especially when their customer service experience was good. The system therefore increases the number of positive customer service reviews that are received, which increases the ability for a business to broadcast their reviews as a marketing tool to increase business. Individualized reviews of employees also provide opportunities for businesses to highlight good employees with rewards, bonuses and incentives while also using them to advertise an exceptional employee to potential customers.

Throughout the application, the term “review” will be used to encompass customer service reviews, recommendations, surveys, testimonials, customer satisfaction ratings, rankings, or any type of customer feedback provided by the customer with regard to service performed by an employee.

### System Overview

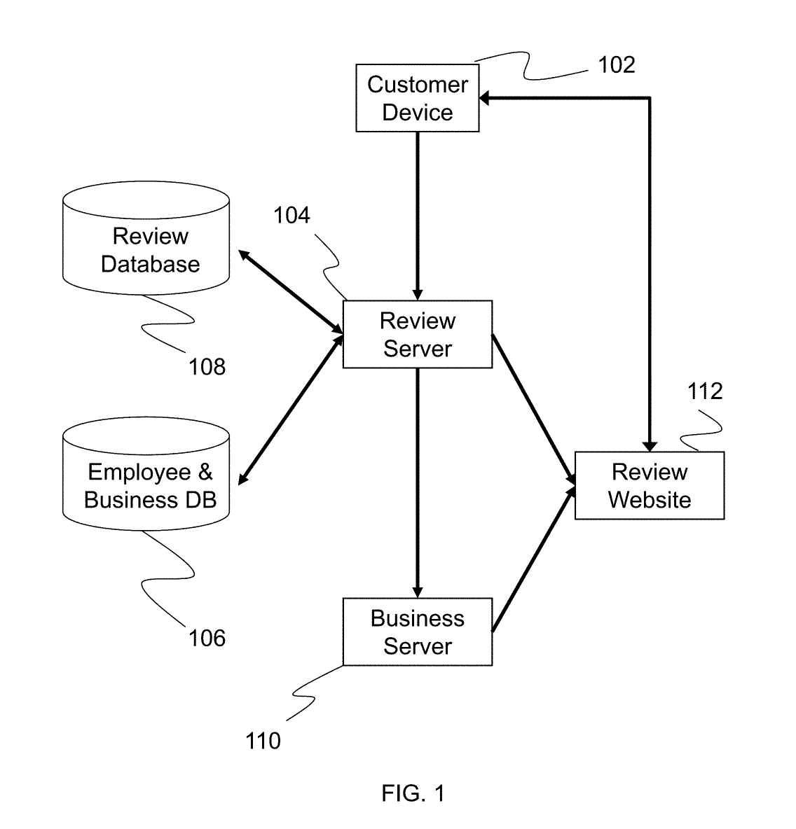

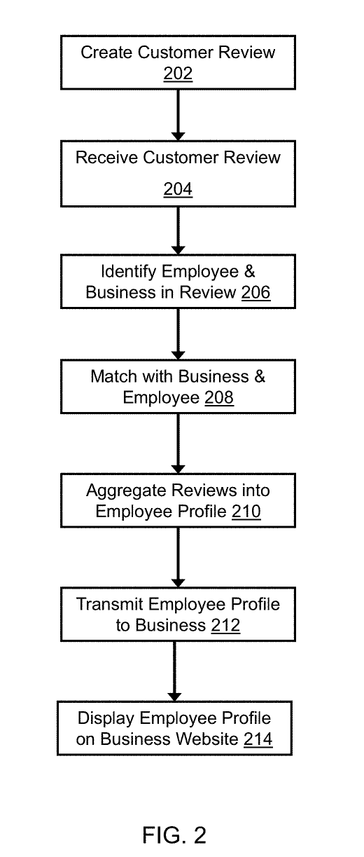

FIG. 1 is an illustration of one embodiment of a system for obtaining and utilizing online customer service reviews, while FIG. 2 illustrates a corresponding method for obtaining and utilizing the online customer service reviews. The review may be created by a customer (step 202) using a customer device 102, such as a desktop computer, laptop computer, tablet, smartphone or any other computing device which allows the user to create a review and transmit the review for further processing. The customer device 102 may interface with the customer to create the review using an application on the customer device 102 or via a web-based interface run by a browser application on the customer device which transmits the content of the review directly to a review server 104 while the review is being completed. Regardless of whether the review is created on the customer device 102 via an application or web-based application interface, the review content is then transmitted to the review server 104 as a review data file.

The review server 104 receives the online customer service review (step 204) and identifies a business or service provider and an individual employee who is the subject of the review (step 206). Although the review may be received directly from the customer, in some embodiments, the review may be obtained from a third-party source, such as through communication with a third-party review website or database, a business website or even physically written reviews which are scanned or manually transposed into electronic format. The identification step may be completed by identifying keywords or fields of the review (such as fields labeled “Business Name” or “Employee Name”) or through the use of embedded data in the review file which has already identified the service provider and individual employee. For example, the user may have received an invitation via an email or text message to create a customer service review which uses a unique hyperlink that takes the user to an application or webpage which has already identified the service provider and individual employee based on the service provider's own records.

Once the service provider and employee are identified, the review server 104 will match the identified service provider and employee (step 208) with a list of service providers and employees stored in an employee and business database 106. The matching step may be performed simply by matching the names of the service provider and employee with names in a database table in the database 106. The employee and business database 106 will also contain contact information for the business and employee in order to determine where to transmit the online customer service review and other related information. The contact information could be an IP address of a business server 110, an email address or other messaging protocol address.

The review server 104 may also be configured to store the received online customer service reviews in a review database 108 which associates the reviews with the matched service provider and employee. This information may be utilized in order to aggregate multiple reviews for one employee into an employee review profile (step 210) which provides an overall summary, rating and other content about the employee and their history of reviews. In one embodiment, a service provider profile may also be compiled of all of the employees that work for the service provider in order to list the employee review profiles of all employees in a single user interface for the service provider. Further details of the employee review profile are described herein.

The received online customer reviews or aggregated employee/service provider profiles may then be transmitted to the business or service provider (step 212) via transmission to the business server 110 operated by the business or service provider. The business or service provider may then display the online customer reviews or aggregated profiles on a review website 112 (step 214), such as a business website, employee profile website, third party review website, social media page, advertisement, etc. The business server 110 may receive the reviews or aggregated profiles and format or reorganize the information for display on their own review website, but in another embodiment, the review server 104 can directly create a user interface for the reviews of a particular employee or service provider's aggregated profiles and reviews and display the information on a separate review website. Additional customers on their own customer devices 102 may then be able to view the review website 112 to determine which service provider or employee they wish to hire for a particular service.

### System Workflow

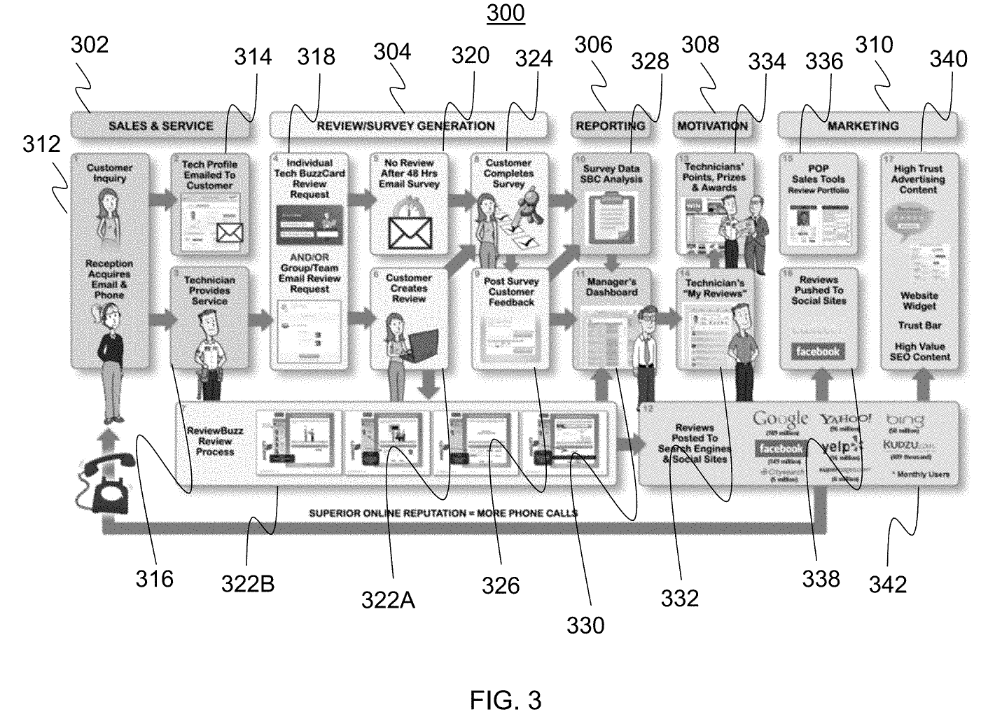

FIG. 3 illustrates one embodiment of a system and method for obtaining and utilizing online customer service reviews illustrating an overall workflow 300 of a sales and service process 302, a review generation process 304, a reporting and organization process 306, a motivation process 308 and a marketing process 310. This embodiment is directed to an employee of a direct service provider such as a plumber or electrician, although the system is equally applicable to any business with one or more employees which provide customer service and may receive customer service reviews. At the beginning of the sales and service process 302, a customer inquiry 312 is received from a customer who is interested in a business and inquires with that business for a quote to perform a particular service. The request may be made online through the business' website or via e-mail or phone, and the customer may then be provided with a quote and one or more review profiles 314 about one or more of the employees of the company that will be providing the service. The customer can then pick one or more of the employees that they would like to provide the service based on the review profiles of the employees.

The employee will then provide the requested service during a service appointment 316, after which time the review generation process 304 begins when the customer is asked by the employee or the employee's company to complete a review 318 by providing the customer with information on how to complete a review of the customer service they've received during the service appointment. The information may be provided to the customer with a simple information card, or by an email or text message to the customer, and may emphasize that the customer is being asked to review the performance of the individual employee who is providing service, in addition to or instead of a review of the business in general. If the customer does not complete a review within a certain amount of time 320, a reminder may be sent to the customer to follow up and request that the customer complete the review in order to increase the number of reviews obtained.

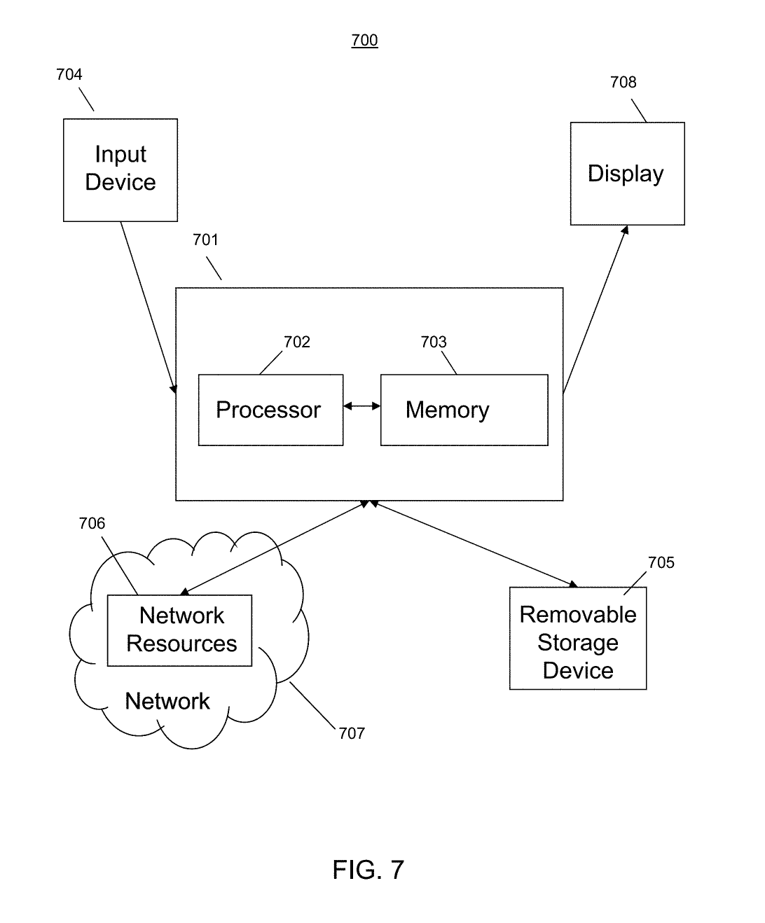

In one embodiment, the customer may complete the review 322A, a survey 324 or provide feedback 326 using a computing device with a display and an input, as is described further below in FIG. 7. The computing device may be the customer's home computer, laptop, tablet, smartphone or interactive television. The computing device may access a web-based application where the review can be completed or utilize software on the computer or smartphone which helps the user complete the review and then uploads the review to a central review server. The system may provide a proprietary user interface 322B for creating a customer service review, or the customer may also be able to complete the review using a third-party review service, after which the review may be obtained by the central review server and aggregated with other reviews. The system may therefore be configured to provide the user with the ability to create a review using the customer's preferred reviewing service, and then obtain that review afterwards for inclusion into the other reviews being collected at the central review server.

Once the review is completed, it may then be analyzed and classified in the reporting and organizing process 306 based on multiple factors, including the employee and business that it pertains to. If the review was a survey, the survey data may be evaluated using a net promoter score (NPS), SBC analysis or other method 328. The NPS evaluation may be computed for each employee and for the company overall. The reviews are therefore organized at the central review server in order to classify the reviews and generate summaries of the reviews in various formats, including a manager dashboard, administrator dashboard of reviews 330 of all employees and an employee review profile 332 which helps to summarize the review information.

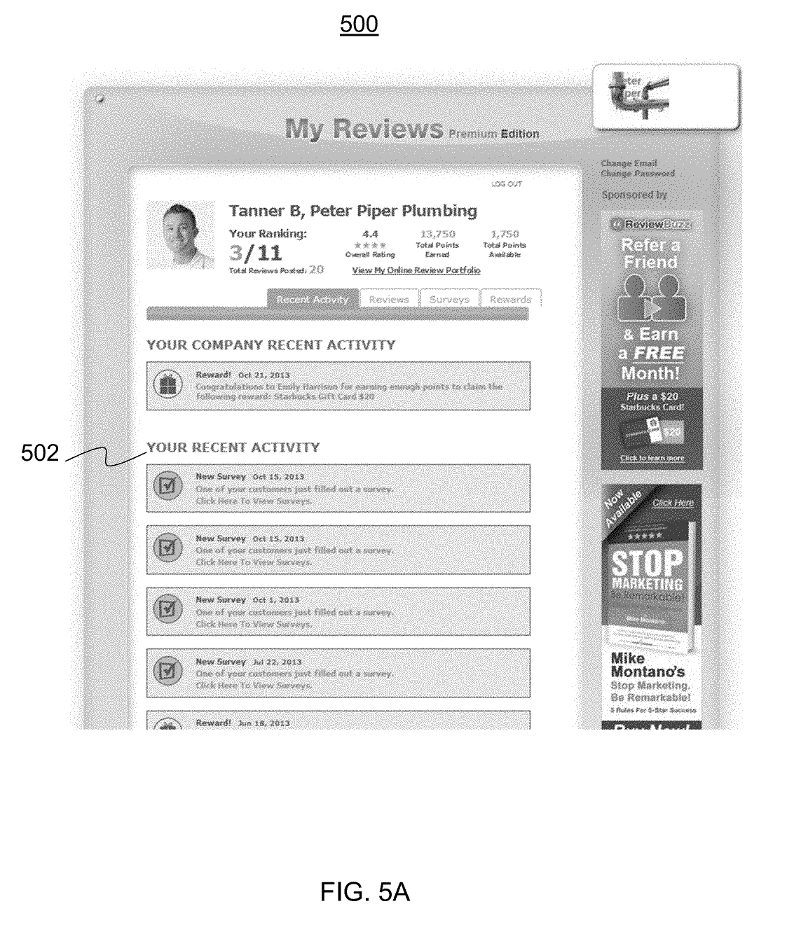

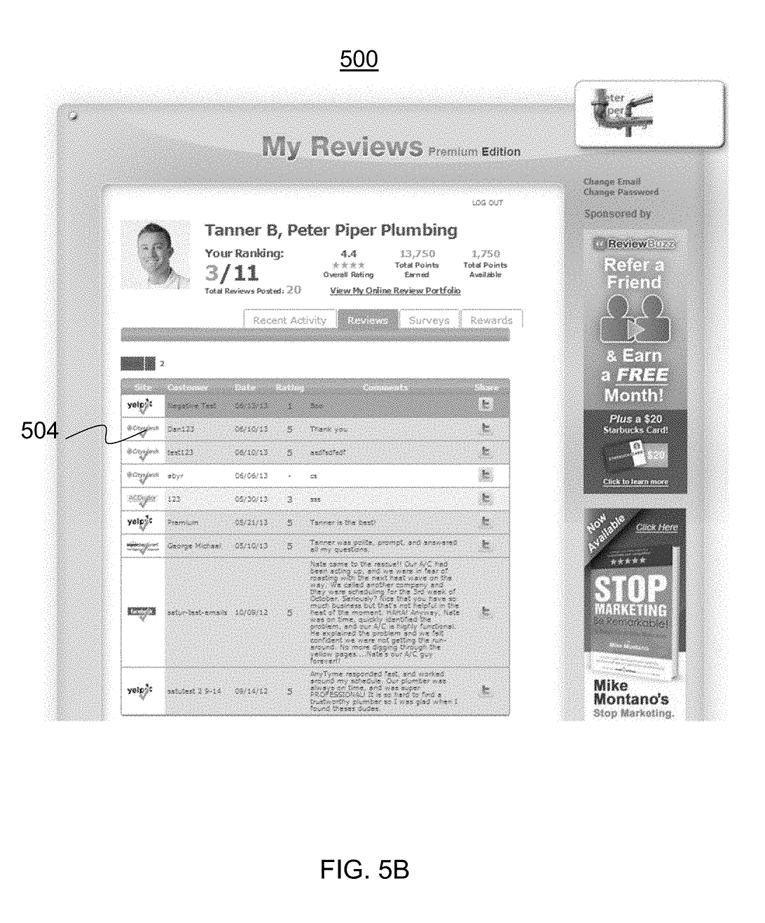

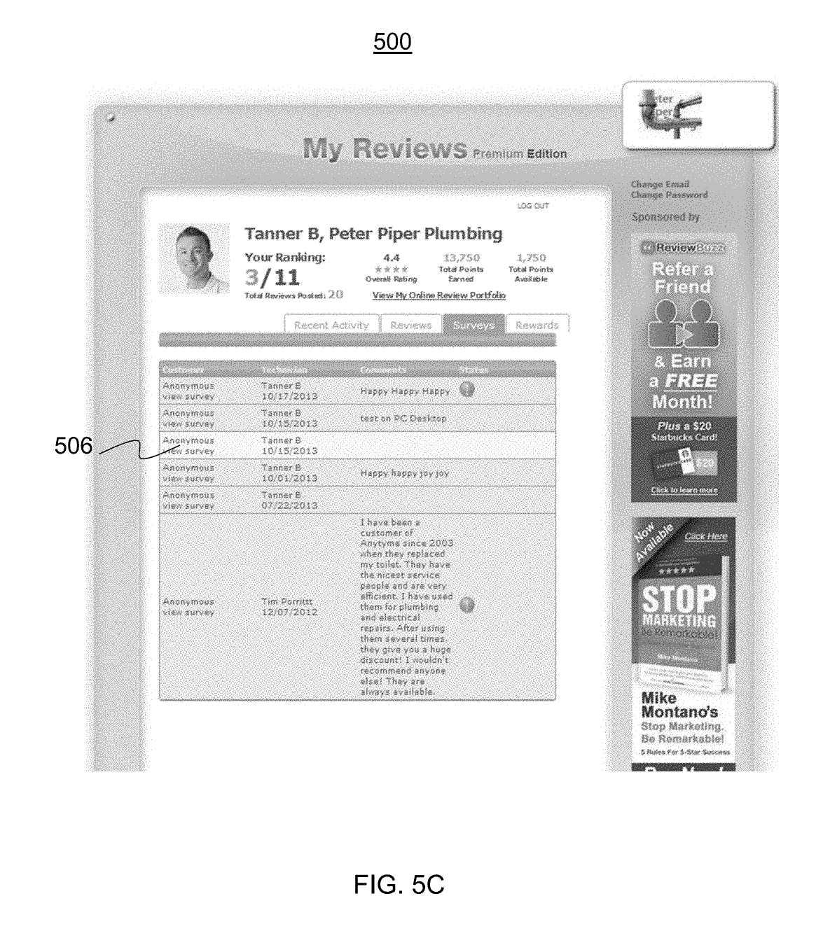

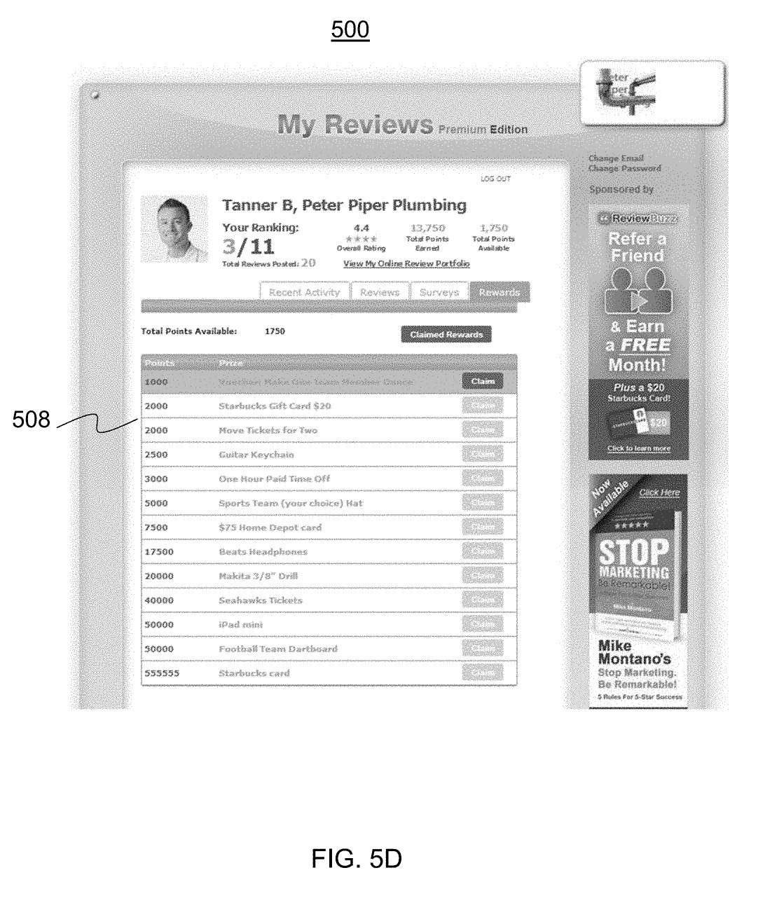

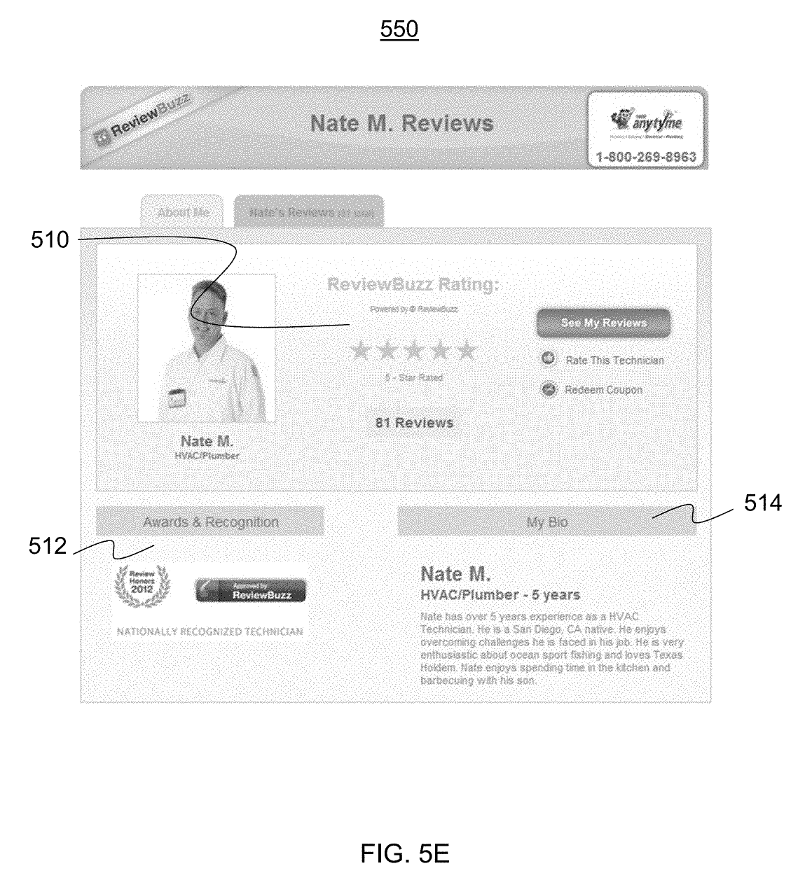

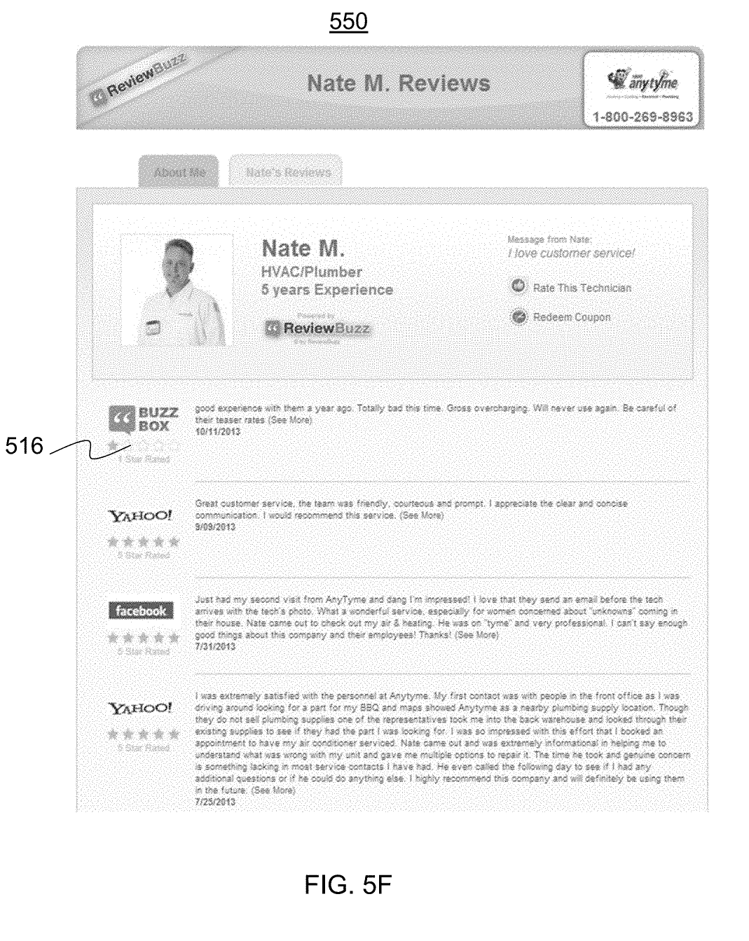

The reviews for a particular employee are aggregated and organized into an employee review profile 500 (see FIGS. 5A-5F), which is a graphical user interface (GUI) that may list notifications 502 of updates to the employee profile, employee rankings 504, one or more of the customer reviews 504 for that employee, employee surveys 506 along with additional information about the employee, such as the employee's training, experience, location, etc. The employee profile may also list rewards 508 the employee has earned, awards and other recognitions that the employee has received. The employee profile serves not only as a summary for the employee to see his or her performance, as illustrated in FIGS. 5A-5D, but also as a marketing tool that the business can use to market the service provided by that particular employee, as illustrated in FIGS. 5E-5F. FIG. 5E therefore illustrates a publicly-available employee profile 550 which displays an employee rating 510, awards 512 and a biography 514. In FIG. 5F, detailed third party reviews 516 are displayed so the customer can see reviews from multiple different sources. The employee review profile 332 is part of the motivation section 308, which is utilized along with incentives 334 such as points, prizes and awards to give the employee and incentive to provide better customer service.

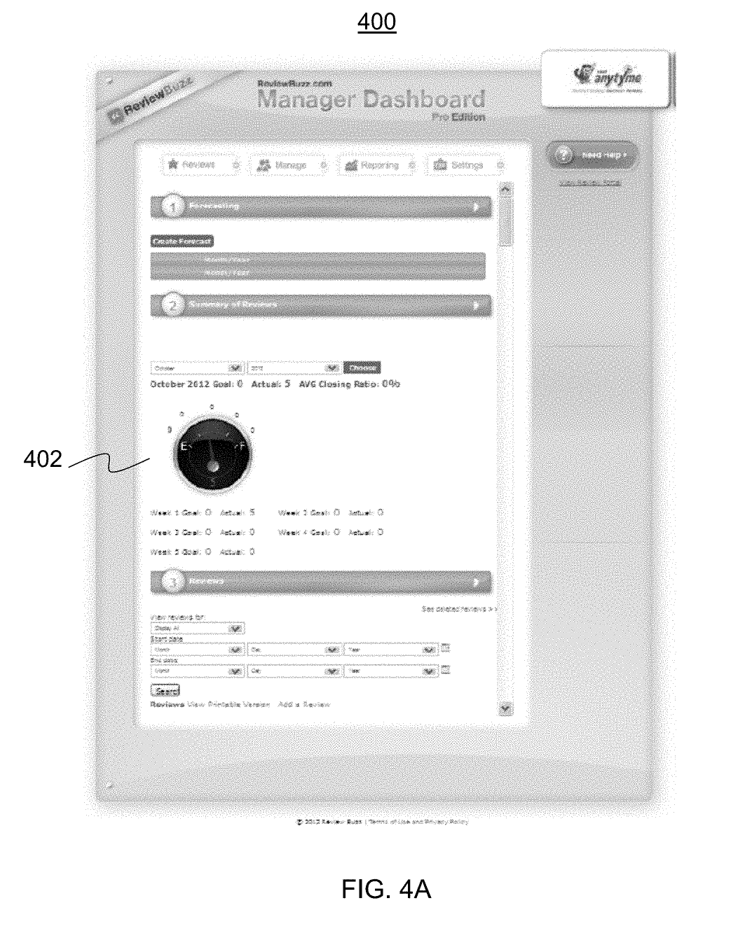

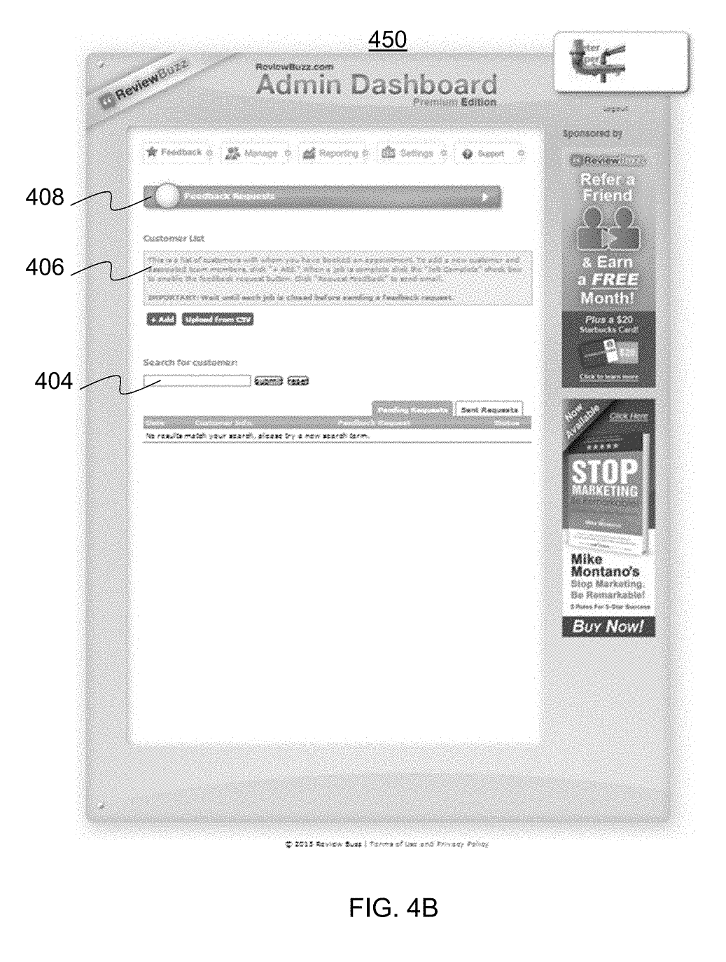

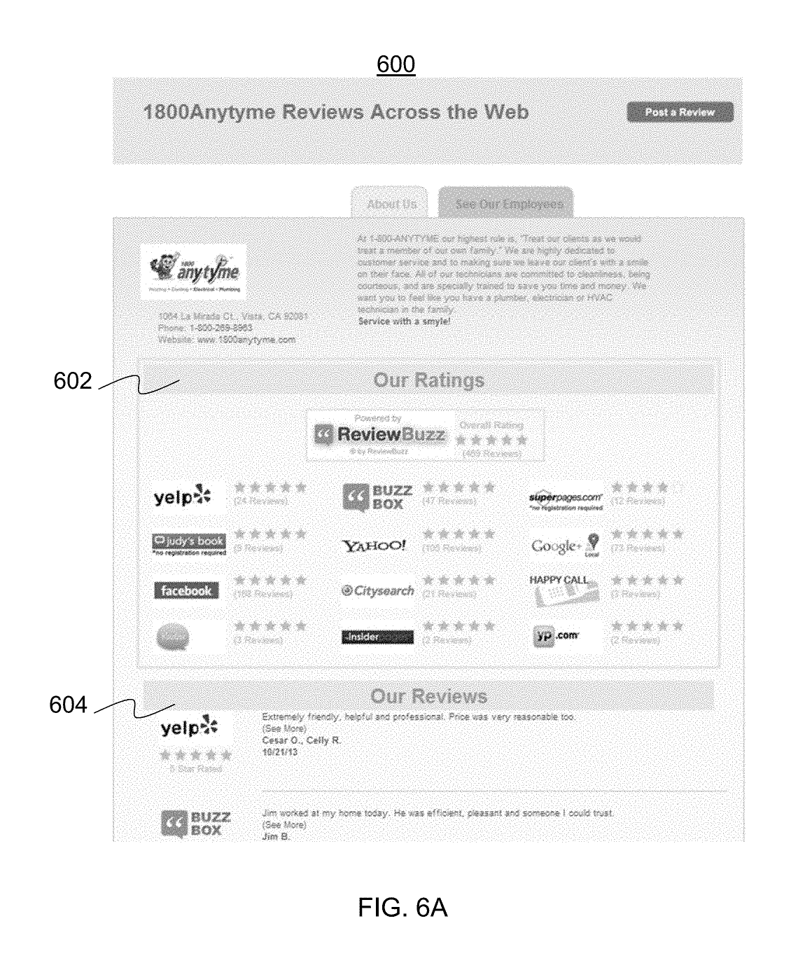

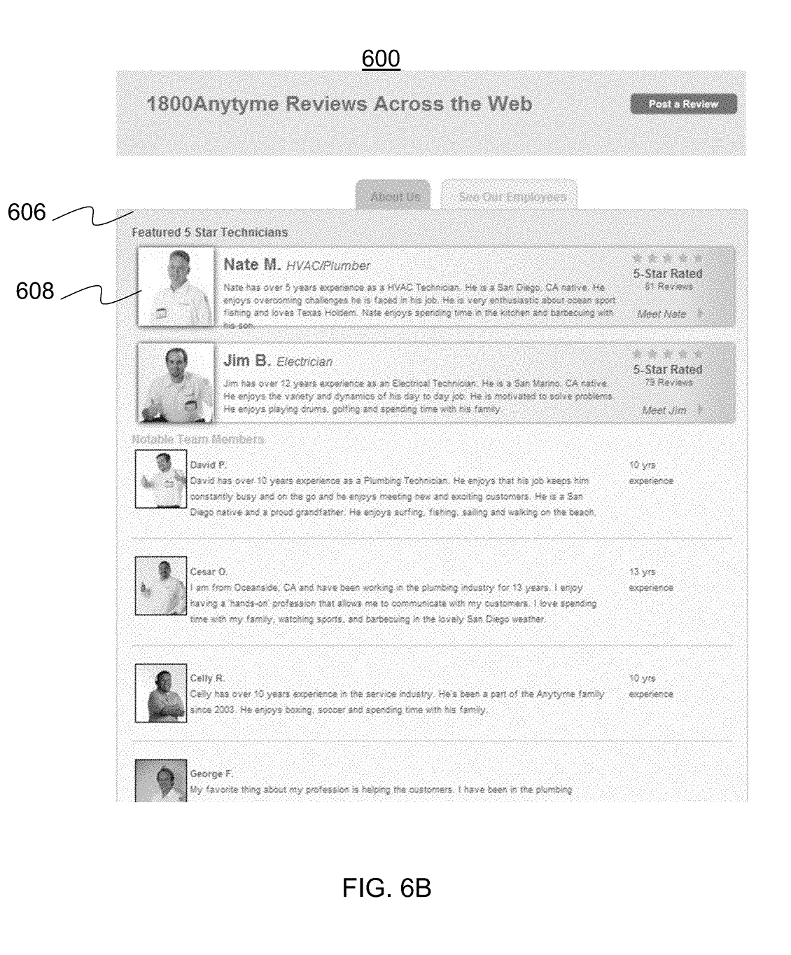

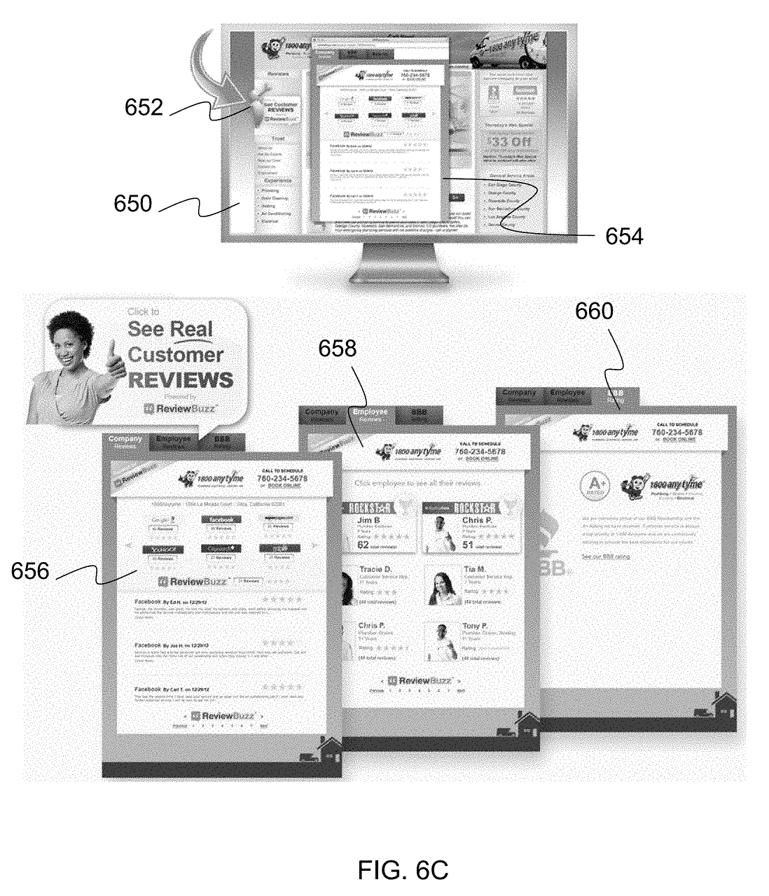

The review information may also be organized into the manager dashboard in FIG. 4A or the administrator dashboard in FIG. 4B. The manager dashboard 400 may provide additional analytics 402 of the reviews in order to help the employee and the business determine how their employees are performing, whether customers are completing reviews, whether their overall reputation is increasing or decreasing and other marketing strategies of how to broadcast the reviews to various destinations for advertising and marketing. The administrator dashboard 450 may provide options to search customers 404 or view customer lists 406, manage feedback requests sent to customers 408 and perform other administrative tasks. The business may then provide rewards and incentives to their employees 334 based on the reviews they are receiving, make decisions on salaries, pay and bonuses based on rankings of employee reviews, etc. A publicly-available business review profile 600 is illustrated in FIGS. 6A and 6B, showing overall ratings 602 for a plurality of review sites, specific reviews 604 and an employee profile page 606 which displays the ratings and reviews for each individual employee 608 than can then be selected to view the overall employee profile shown in FIGS. 5E and 5F.

Once the reviews are organized and classified, the individual employee review profiles 550, an overall business review profile 600 (illustrated in FIGS. 6A-6B) or even individual positive reviews may be broadcast to various destinations for use in marketing and advertising the business in the marketing process 310. This may include posting the reviews on the business' website 336, posting the reviews to a social media profile of the business 338 or the employee or placing online advertisements of the reviews on various websites 340 where the business advertises. In addition, the reviews can be broadcast to other third-party review services 342, such as search engines, directory search websites, yellow pages services, and other websites which display business information and collect customer service reviews. The reviews may be displayed on the business' website 650 using various user interfaces, such as a widget 652 which generates a review window 654, as illustrated in FIG. 6C. If a customer is viewing the business website 650, the customer can select the widget 652 and have a review window 654 displayed with different tabs showing different review information. A company tab 656 shows the business review profile illustrated in FIG. 6A, while the employee tab 658 shows the employee profile page 606 shown in FIG. 6B. A third-party reviews tab 660 may show a third party official rating, such as that of an accredited reviewing organization.

In one embodiment, the reviews may be sent out via e-mail or other electronic messages to regular or potential customers. The review information may be organized in the form of an advertisement of a particular employee, of the business and the employee or of the business generally. As already mentioned above, the employee review profiles may also be used to distribute to potential customers interested in using the business, so that they can select a particular employee based on the employee's reviews.

### Individualized Employee Reviews

As described above, the customer service reviews are directed to an individual employee that is providing the service. Customers are more likely to complete a review of an individual person than a business, and are also more likely to report a positive review of an individual who provides good service rather than the general business. Therefore, by requesting and emphasizing that the review is for the individual employee, the customer is more likely to complete the review and to turn in positive reviews. The employees are encouraged to personally invite the customer to complete a review of them during the service appointment, which also increases the chance that the customer will complete a review and that a customer who receives a positive customer service experience will want to reward that employee with a positive review.

By providing individual reviews, the employees themselves are also more motivated to provide better customer service, as they know that their specific performance will be tied to their specific reviews. Employees that provide excellent customer service will therefore be much more likely to receive excellent reviews. Furthermore, by obtaining individualized customer reviews, the business can provide rewards, incentives, bonuses and raises to employees based on the reviews. The employer therefore has a better ability to evaluate and reward employees. Other motivational programs may be devised to motivate or reward an employee based on their individualized reviews, as would be apparent to one of skill in the art.

In addition, individual reviews of employees can be broadcast to potential customers, who will be more likely to use a particular business if they know the specific employee they have selected has a reputation for providing excellent customer service.

### Automated Reputation Management

The systems and methods described herein provide a complete customer service review process from start to finish that requires minimal involvement on the part of the business and the employee. The service is configured to handle the review requests to the customers, receive and manage the process of obtaining the customer reviews, aggregate and organize the review information, create review profiles and dashboard interfaces for the employees and businesses, and broadcast the review information to websites, social media and messaging in order to advertise and market the business' and employees' reputations.

### Mobile Platform for Reviews

In one embodiment, the systems and methods for requesting, receiving, organizing and broadcasting customer service reviews may be incorporated onto a mobile platform for use on a portable electronic device. The mobile review platform may be a standalone system that is implemented through a software application running on the mobile device and interfacing with the central review server, or the mobile review platform may be integrated with another mobile platform related to the business. For example, a business may provide a mobile application to smartphone or tablet users that provides information on the customer's accounts, allows the customer to shop for items, request services, etc. The review platform may therefore be integrated with that application interface so that whenever a customer makes a purchase or interfaces with the application to request a service appointment, the opportunity to create a customer review is provided.

In one embodiment, the mobile review platform may be integrated with a mobile payment system, so that when a customer makes a payment for a product or service, the opportunity to create a customer service review is immediately provided to the customer upon completion of the payment. This will increase the likelihood that the customer will complete a review, since the review will be requested as soon as the payment is complete.

In one embodiment, having the review tied to the payment process also provides a built-in authentication of the review that ensures that the person completing the review is the person who actually received the service from the employee. Reviews which can be confirmed to have been created by an actual customer who received service from a specific employee are much more valuable to a potential customer reading the review and the employer and employee who received the review. As many third-party review services have no way of verifying that the person completing the review actually interacted with the company or even a specific employee within the company, the integration of reviews with mobile payment eliminates the uncertainty that is found in customer reviews. This authentication feature therefore provides an automatic verification of the review since it is tied to the mobile payment process, and may even be used to filter reviews based on whether they have been authenticated or not. A company or a customer may be allowed to filter the reviews based on whether they have been verified in order to see reviews that they know have been tied to a specific customer service experience or product purchase.

### Computer-Implemented Embodiment

FIG. 7 is a block diagram illustrating an example wired or wireless system that may be used in connection with the various embodiments described herein. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

1. A method of verifying online customer service reviews for a plurality of employees of a plurality of service providers, comprising:
receiving, at a memory, a plurality of online customer service reviews of the plurality of individual employees based on customer service received from the plurality of individual employees and a payments to the plurality of service providers;
verifying, by one or more processors communicatively coupled to the memory, the plurality of customer service reviews are received from the customer receiving the customer service in each instance;
identifying, by the one or more processors, a service provider of the plurality of service providers associated with the an employee of the plurality of employees based on a first online customer service review of the plurality of online customer service reviews;
matching, by the one or more processors, the service provider and the employee to a list of service providers and individual employees stored in the memory; and
transmitting the online customer service review to the service provider based on the matching.

2. The method of claim 1 further comprising requesting, by the one or more processors, a customer of the service provider complete the online customer service review of the individual employee.

3. The method of claim 1, further comprising transmitting the online customer service review to the employee.

4. The method of claim 1, further comprising displaying the online customer service review on a website.

5. The method of claim 4, wherein the website is selected from at least one of: a service provider website, an individual employee website and a third party review website.

6. The method of claim 1 further comprising aggregating, by the one or more processors, the customer service review with additional customer service reviews for the employee to create an employee review profile.

7. The method of claim 6 further comprising displaying, by the one or more processors, the employee review profile on a website selected from at least one of: a service provider website, an individual employee website and a third party review website.

8. The method of claim 6 further comprising displaying the employee review profile as an advertisement.

9. The method of claim 6 further comprising aggregating, by the one or more processors, the employee review profile into a service provider profile which displays one or more employee review profiles of individual employees.

10. The method of claim 9 further comprising displaying the service provider profile on a website selected from at least one of: a service provider website, an individual employee website and a third party review website.

11. A system for verifying online customer service reviews for an employee of a service provider, comprising:
a customer device configured to complete an online customer service review of the employee der based on customer service received from the employee, and transmit the online customer service review;
a review server configured to:
receive the online customer service review of the employee,
verify the customer service review is received from the customer receiving the customer service;
identify the service provider and employee in the received online customer service review,
match the service provider and employee in the received online customer service review with a list of service providers and individual employees stored in an employee and service provider database, and
transmit the online customer service review; and
a service provider server configured to receive the online customer service review.

12. The system of claim 11 further comprising a display screen connected with the service provider server for displaying the transmitted online customer review to the service provider.

13. The system of claim 11, wherein the review server is further configured to aggregate the received customer service review with additional customer service reviews for the individual employee to create an employee review profile.

14. The system of claim 13, wherein the service provider server produces a website of the online customer service review and employee review profile.

15. The system of claim 14, wherein the website selected from at least one of: a service provider website, an individual employee website and a third party review website.

16. The system of claim 14, wherein the review server is connected with a review database which stores the received online customer service review and the employee review profile.

17. A method of verifying online customer service reviews for an employee of a service provider, comprising the steps of:
transmitting, by one or more processors, a request for an online customer service review of the service provider based on a payment to the service provider;
receiving the online customer service review;
verifying the plurality of customer service review is received from the customer receiving the customer service;
identifying the employee and the service provide based on content of the online customer service review; and
associating the content with an individual employee review profile.

18. The method of claim 17, further comprising aggregating the employee review profile into a service provider profile which displays one or more employee review profiles of individual employees.

19. The method of claim 18, further comprising displaying the employee review profile or service provider profile on a website selected from at least one of: a service provider website, an individual employee website and a third party review website.
